(19) United States
(12) Patent Application Publication
(10) Pub. No.: US 2026/0071901 A1
(43) Pub. Date: Mar. 12, 2026

(54) FLOW SENSOR DISC

(71) Applicant: UWM Research Foundation, Inc., Milwaukee, WI (US)

(72) Inventors: Nathan Salowitz, Whitefish Bay, WI (US); Armin Yazdi, Milwaukee, WI (US); Li-Chih Tsai, Milwaukee, WI (US)

(21) Appl. No.: 18/872,606

(22) PCT Filed: Jun. 26, 2023
(86) PCT No.: PCT/US2023/026247

§ 371 Date: Dec. 6, 2024

Related U.S. Application Data
(60) Provisional application No. 63/355,882, filed on Jun. 27, 2022.
(60) Provisional application No. 63/411,873, filed on Sep. 30, 2022.

(51) Int. Cl. G01F 1/28; G01F 1/38

(52) U.S. Cl. CPC G01F 1/28; G01F 1/38

(57) ABSTRACT

A flow sensor disc includes an outer ring, a beam, a first flap, a second flap, a first flow opening, a second flow opening, and a multi-directional strain sensor. The beam extends across the outer ring. The first flap extends from the beam. The second flap extends from an opposite side of the beam as the first flap. The first flow opening is defined between the first flap and the outer ring. The second flow opening is defined between the second flap and the outer ring. The multi-directional strain sensor is supported by the beam.

### CROSS REFERENCE TO RELATED APPLICATIONS

This application claims priority to U.S. Provisional Patent Application No. 63/355,882, filed Jun. 27, 2022, and U.S. Provisional Patent Application No. 63/411,873, filed Sep. 30, 2022, the entire contents both of which are hereby incorporated by reference.

### TECHNICAL FIELD

The present disclosure relates to flow sensor discs, methods of manufacture, and methods of use. In particular, the disclosure relates to flow sensor discs including a multi-directional strain sensor.

### INTRODUCTION

Flow meters or flow sensors may be used to detect a leak and/or measure the flowrate of fluid in a pipe. Leak detection is important for monitoring the status of water systems including degradation of seals, valves, and other components. Measurement of fluid flow at non-low flowrates may be useful for monitoring usage.

To detect both leaks and measure the flowrate in a pipe, a flow meter should be able to detect and quantify ultra-low flowrates (e.g., flowrates under 50 mL/min) and non-low flow rates (e.g., flowrates above IL/min). Traditionally, most flow meters are not multi-range flow meters because the flow meters cannot measure and quantify both ultra-low flowrates and moderate flowrates. Additionally, traditional low-flowrate (or ultra-low flowrate) flow meters are expensive to produce.

### SUMMARY

In one aspect, a flow sensor disc is disclosed. An example flow sensor disc includes an outer ring, a beam, a first flap, a second flap, a first flow opening, a second flow opening, and a multi-directional strain sensor. The beam extends across the outer ring. The first flap extends from the beam. The second flap extends from an opposite side of the beam as the first flap. The first flow opening is defined between the first flap and the outer ring. The second flow opening is defined between the second flap and the outer ring. The multi-directional strain sensor is supported by the beam.

In another aspect, a method of assembling a flow sensor is disclosed. The method comprising, depositing a silicone-based material into a mold; curing the silicone-based material in the mold to generate a disc; removing the disc from the mold, depositing graphene oxide into the frame; and thermally reducing the graphene oxide to reduced graphene oxide, thereby generating the flow sensor disc. The mold defines an outer ring, a beam extending across the outer ring, a first flap extending from the beam, a second flap extending from an opposite side of the beam as the first flap, a first flow opening defined between the first flap and the outer ring, a second flow opening defined between the second flap and the outer ring, and a frame.

Other aspects of the disclosure will become apparent by consideration of the detailed description and accompanying drawings. Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways

### BRIEF DESCRIPTION OF THE DRAWINGS

FIG. 1 shows an example flow sensor system.

FIG. 2 is a front plan view of an embodiment of a flow sensor disposed in a pipe.

FIG. 3 is a front perspective view of the flow sensor of FIG. 2 according to some embodiments.

FIG. 4 is a front perspective view of a flow sensor disc body of FIG. 2 according to some embodiments.

FIG. 5 is a front plan view of the flow sensor disc body of FIG. 4 according to some embodiments.

FIG. 6 is a rear plan view of the flow sensor disc body of FIG. 4 according to some embodiments.

FIG. 7 is a front plan view of the flow sensor disc body of FIG. 4 according to some embodiments.

FIG. 8 is another front plan view of the flow sensor disc body of FIG. 4 according to some embodiments.

FIG. 9 is yet another front plan view of the flow sensor disc body of FIG. 4 according to some embodiments.

FIG. 10 is a side view of the flow sensor disc body of FIG. 4 according to some embodiments.

FIG. 11 is another side view of the flow sensor disc body in FIG. 4 according to some embodiments.

FIG. 12 is a front perspective section view of the flow sensor disc body of FIG. 4 according to some embodiments.

FIG. 13 is a section view of the flow sensor disc body of FIG. 4 according to some embodiments.

FIG. 14 is another section view of the flow sensor disc body of FIG. 4 according to some embodiments.

FIG. 15 is a front plan view of the flow sensor disc of FIG. 2.

FIG. 16 is a section view of the flow sensor disc body of FIG. 15 according to some embodiments.

FIG. 17 is a side view of a flow sensor disc in a low-flow regime according to some embodiments.

FIG. 18 is a side view of a flow sensor disc in a non-low-flow regime according to some embodiments.

FIG. 19 is a front perspective view of a flow sensor disc body mold according to some embodiments.

FIG. 20 is a schematic of the computing system of the flow sensor disc of FIG. 1 according to some embodiments.

FIG. 21 is a flow chart of a method of assembling a flow sensor according to some embodiments.

FIG. 22A schematically shows wire connections to a experimental sensor. FIG. 22B is a photograph of an experimentally generated and tested sensor.

FIG. 23 shows experimental finite element analysis on the experimental sensor for deformation demonstration.

FIG. 24A shows experimental data of strain contour through a center in the Y direction of an experimental sensor. FIG. 24B shows experimental data of strain contour through a center in the X direction of an experimental sensor.

FIG. 25A shows experimental data of relative resistance change at different flowrates for an experimental sensor. FIG. 25B shows experimental data of resistance at different flowrates for an experimental sensor.

FIG. 26 shows experimental data of pressure drop at different flowrates.

FIG. 27 shows experimental data of resistive response of an experimental sensor during about 40 days of testing under 7.57% strain.

FIG. 28A shows experimental data of relative resistance response for various numbers of cycles in the X direction. FIG. 28B shows experimental data of relative resistance response for various numbers of cycles in the Y direction. FIG. 28C shows experimental data of relative resistance response for various numbers of cycles at an angle.

FIG. 28A shows experimental data of the resistive response of an experimental sensor up to the highest flowrate tested.

### DETAILED DESCRIPTION

Generally, the instant disclosure is directed to flow sensor discs, methods of manufacture, and methods of use. Exemplary flow sensor discs are capable of detecting both low flow and normal flowrates of fluid in a pipe. Exemplary flow sensor discs may also be inexpensive compared to existing devices capable of detecting both low flow and normal flowrates of fluid in a pipe.

### I. Exemplary Flow Sensor Systems

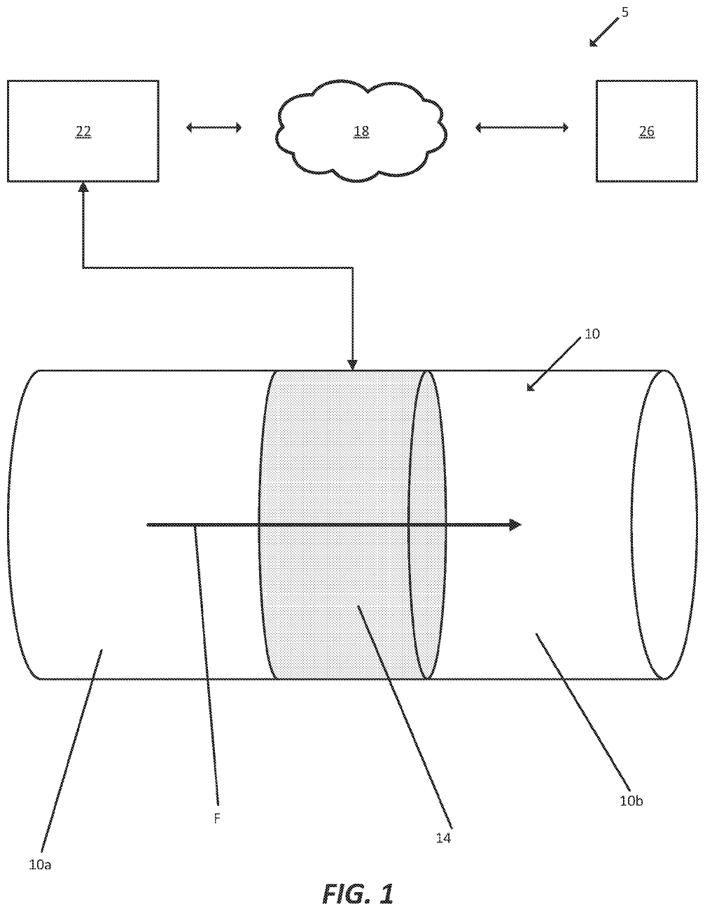

FIG. 1 is a schematic diagram of a flow sensor system 5. As shown, flow sensor system 5 includes pipe 10, flow sensor disc 14, and computing unit 22. Fluid flow F in pipe 10 is also schematically indicated. In some implementations, flow sensor system 5 may additionally include network 18 and user device 26. Other embodiments may include more or fewer components.

The flow sensor system 5 is configured to detect and quantify fluid flow F in a low-flow regime and a non low-flow regime. Exemplary low-flow regimes may include flowrates that are less than 50 millimeters per minute (mL/min). Exemplary non low-flow regimes may include flowrates between 50 mL/min and 10 liters per minute (L/min). In some implementations, the non low-flow regime may include flowrates that are slightly greater than 10 L/min.

The flow sensor system 5 can detect and measure fluid flow F in a variety of pipe sizes. The flow sensor system 5 may configured to be used in an 8 mm pipe, a 15 mm pipe, a 22 mm pipe, or a 28 mm pipe. The flow sensor system 5 may be sized for use in various other pipe sizes.

The flow sensor disc 14 may be disposed between a first pipe segment 10a and a second pipe segment 10b. In some implementations, the flow sensor disc 14 may be disposed at a pipe joint such that the first pipe segment 10a is a first pipe and the second pipe segment 10b is a second pipe.

The computing unit 22 may receive and process data from the flow sensor disc 14. The computing unit 22 may be in wired or wireless communication with flow sensor disc 14.

In some implementations, the computing unit 22 may provide data to a display device or a user device 26. The computing unit 22 may be connected to the display device or the user device 26 by a network 18. Network 18 may be a wired or wireless network.

Exemplary data provided by computing unit 22 may include a quantification of fluid flow in the pipe 10. Exemplary data provided by computing unit 22 may include an alert, such as a low fluid flow alert or a possible leak alert. Additional details regarding computing unit 22 are discussed in greater detail below.

### II. Exemplary Flow Sensor Discs

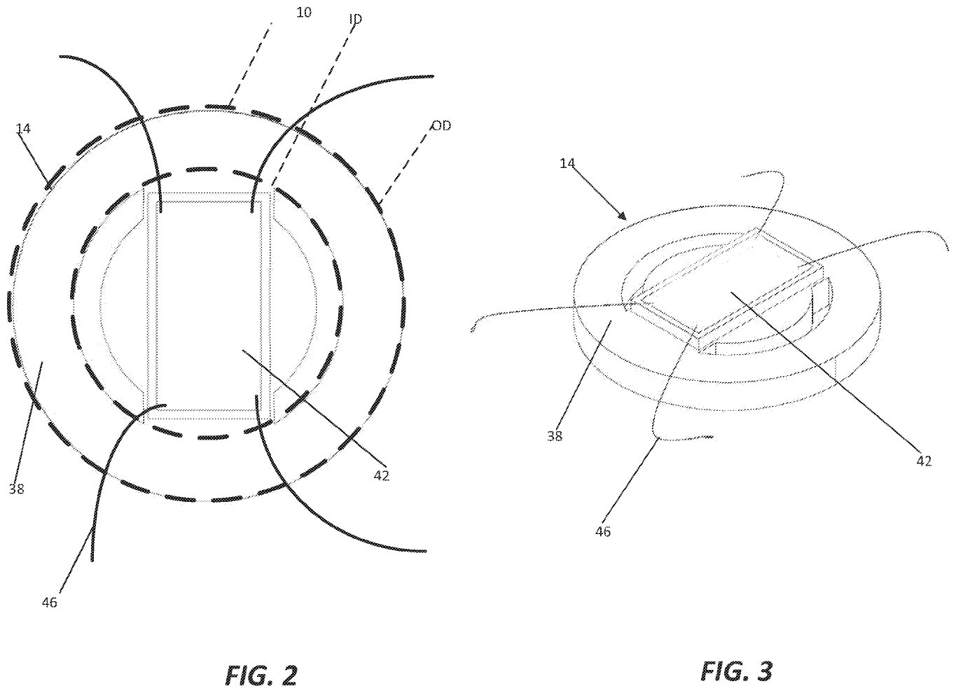

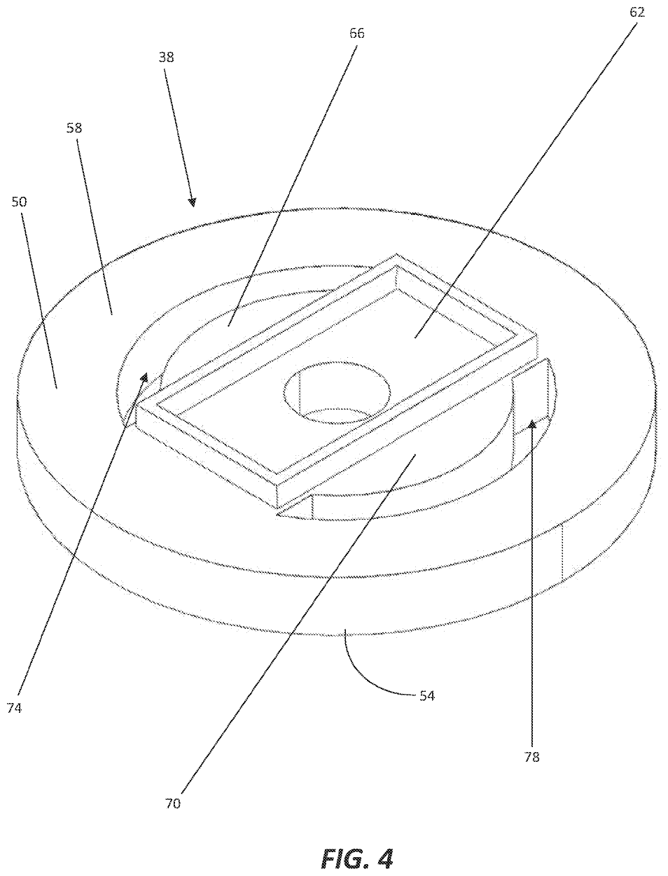

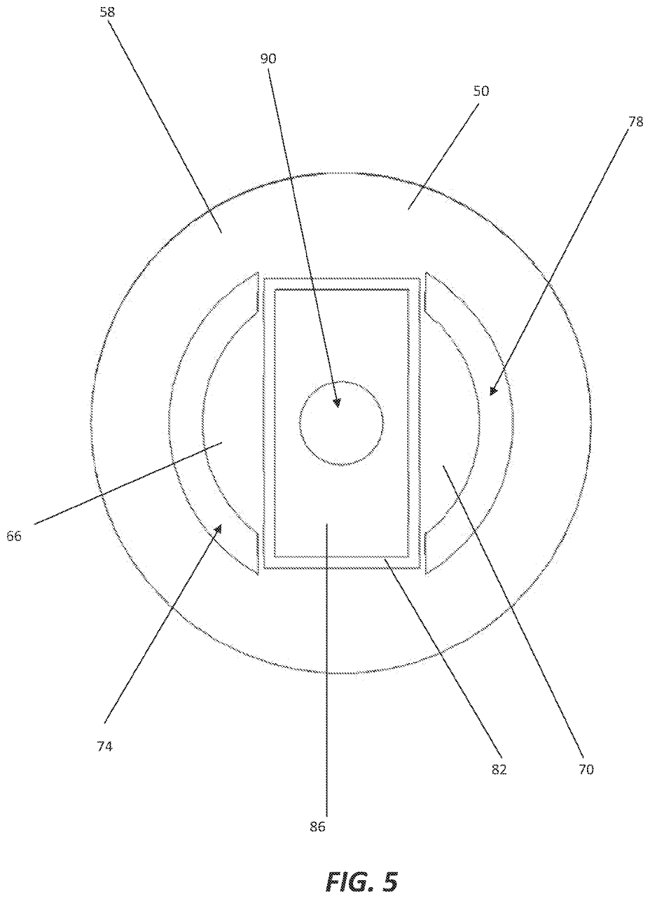

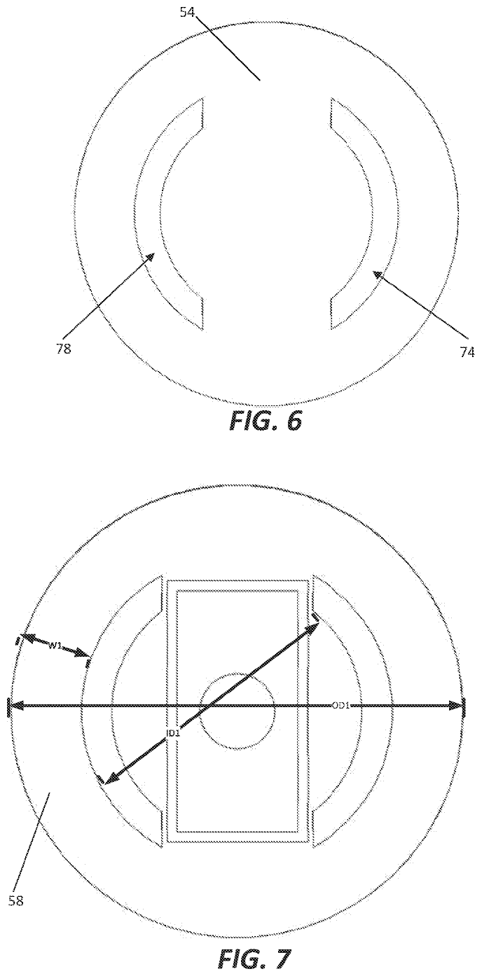

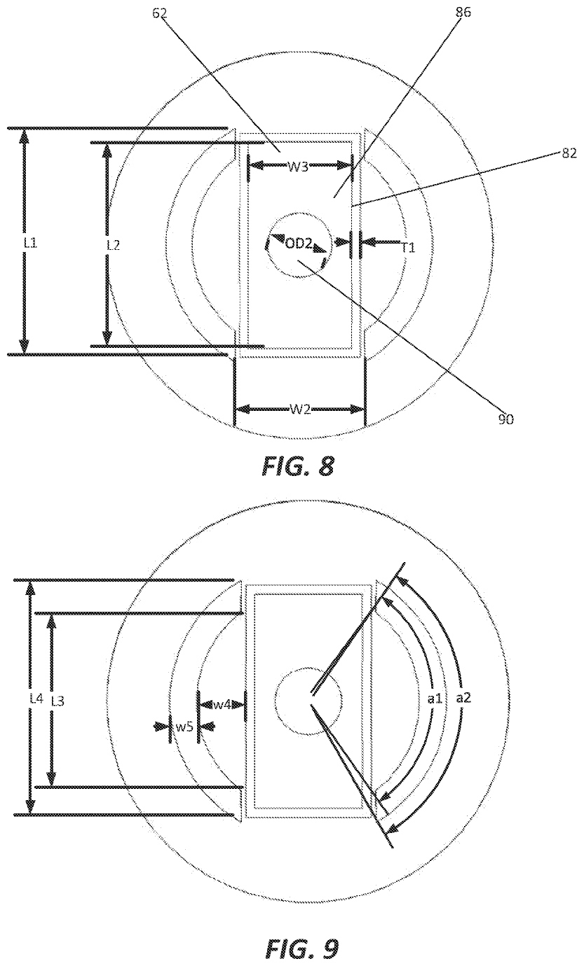

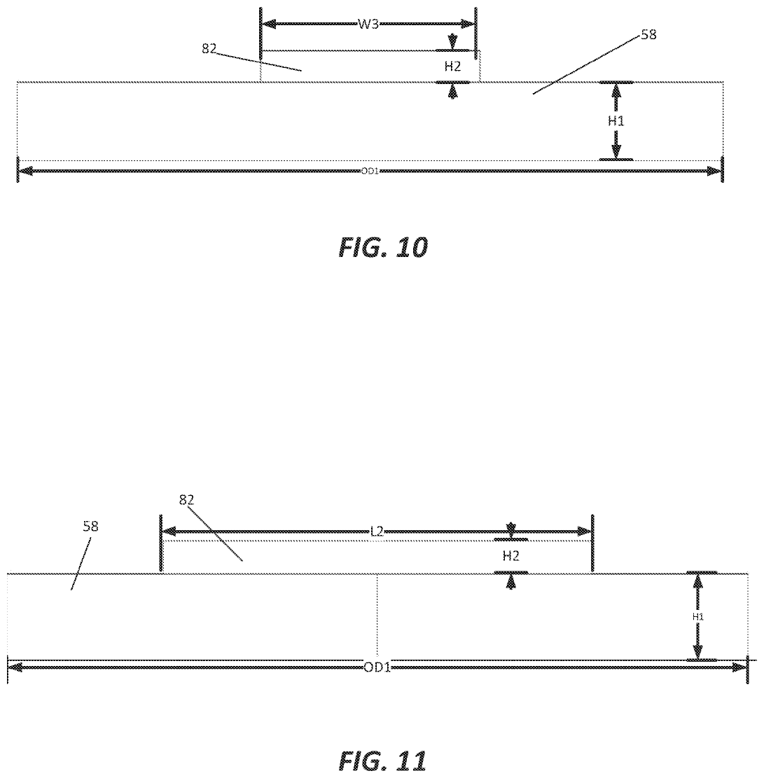

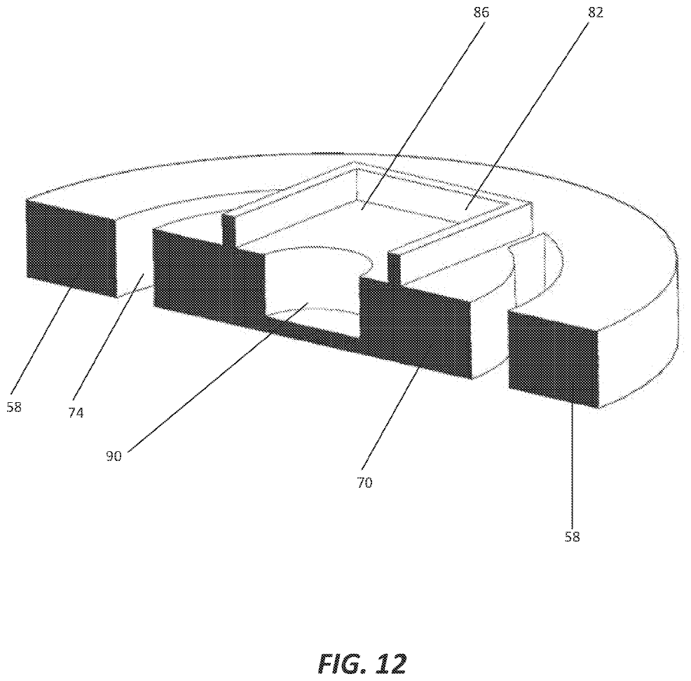

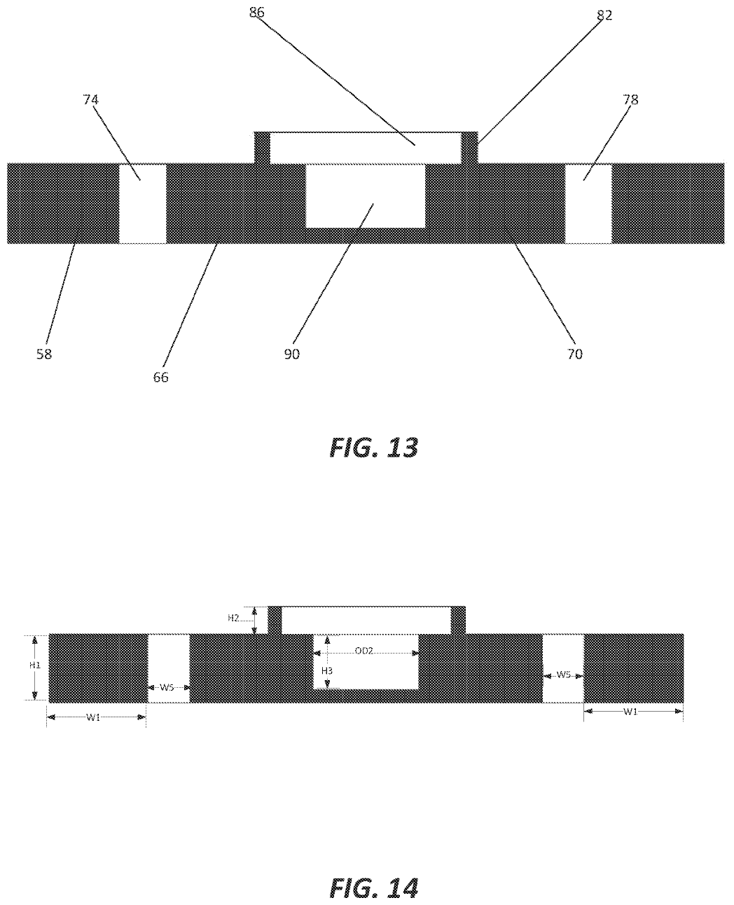

FIG. 2 is a front plan view of an exemplary embodiment of a flow sensor disc 14 positioned in a pipe 10. FIG. 3 is a front perspective view of the flow sensor disc 14 shown in FIG. 2. FIG. 4 is a front perspective view of an embodiment of the disc body 38. FIG. 5 is a front plan view of the disc body 38 of FIG. 4. FIG. 6 is a rear plan view of the disc body 38 of FIG. 4. FIG. 6 is a rear view of the disc body 38 of FIG. 4. FIG. 7 is a front plan view of the disc body 38 of FIG. 4. FIG. 8 is another front plan view of the disc body 38 of FIG. 4. FIG. 9 is yet another front plan view of the disc body 38 of FIG. 4. FIG. 10 is a side view of the disc body 38 of FIG. 4. FIG. 11 is another side view of the disc body 38 of FIG. 4. FIG. 12 is a front perspective section view of the disc body 38 of FIG. 4. FIG. 13 is a section view of the disc body 38 of FIG. 4. FIG. 14 is another section view of the disc body 38 of FIG. 4. Unless otherwise noted, FIGS. 2-14 are discussed concurrently below.

Broadly, the flow sensor disc 14 includes a disc body 38 and a multi-directional strain sensor 42 disposed on the disc body 38.

### A. Exemplary Multi-Directional Strain Sensors

The multi-directional strain sensor 42 generates strain data as fluid flows through pipe 10. Various materials may be used for the multi-directional strain sensor 42, provided the materials are capable of generating strain data. Typically, materials used for multi-directional strain sensor 42 are conductive. As examples, the multi-directional strain sensor 42 may comprise reduced graphene oxide, a metal, or a plurality of strain gauges.

The multi-directional strain sensor 42 may have various thicknesses (T2 in FIG. 16) in different implementations. Generally, the multi-directional strain sensor 42 has sufficient thickness to be conductive. In some instances, the multi-directional strain sensor 42 has a maximum thickness of about 20 μm. Additional details regarding the thickness T2 of the multi-directional strain sensor 42 are provided below.

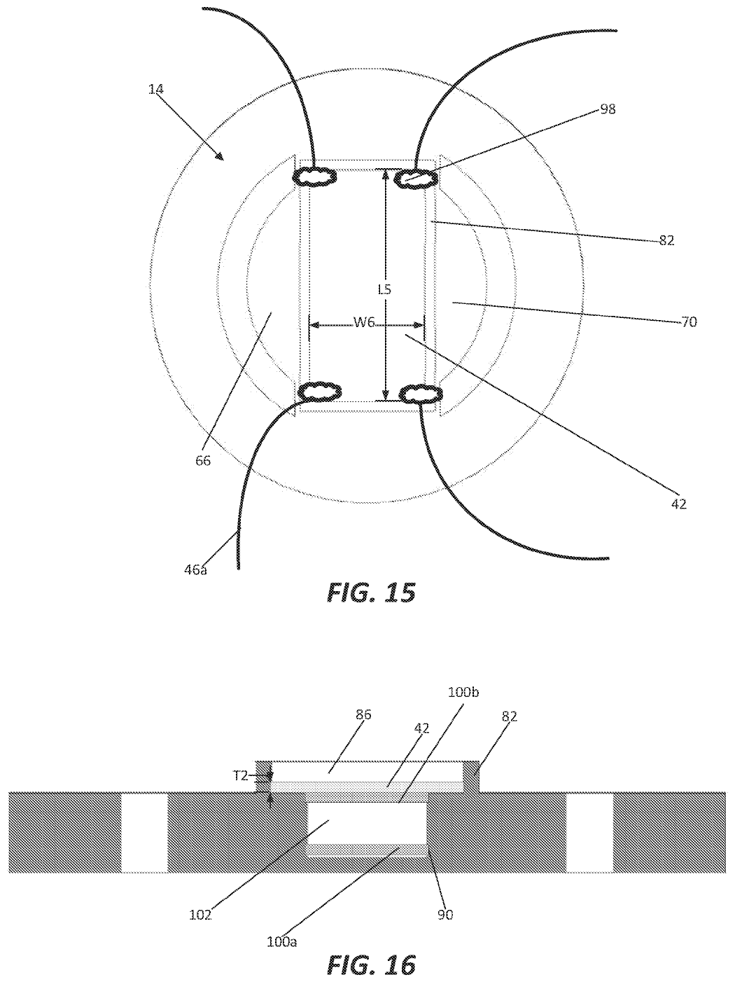

Referring to FIG. 2, FIG. 3, and FIG. 15, a plurality of wires 46 electrically connect the multi-directional strain sensor 42 to the computing unit 22.

The wires 46 are coupled adjacent the corners of the senor 42. The wires 46 may be connected to the multi-directional strain sensor 42 in various ways. For instance, conductive adhesive may be used to connect wires 46 to the multi-directional strain sensor 42. In some implementations, a conductive epoxy may be used to connect wires 46 to the multi-directional strain sensor 42.

Various quantities of wires 46 may be used. For instance, there may be at least two wires 46; at least 3 wires 46; or at least 4 wires 46. In some implementations, there are two wires 46; three wires 46; or four wires 46.

In the illustrated implementation, the flow sensor disc 14 includes four wires that are each coupled adjacent a corner of multi-directional strain sensor 42. This allows the multi-directional strain sensor 42 to measure the strain of the flow sensor disc 14 in three different directions as the beam 62, the first flap 66, and the second flap 70 flex.

In some implementations, the flow sensor disc 14 may include two wires that are each coupled to a diagonal corner of the multi-directional strain sensor 42.

### B. Exemplary Aspects of the Disc Body

The disc body 38 supports the multi-directional strain sensor 42 within the pipe 10. Various aspects of the disc body 38 are discussed in greater detail below with reference to, at least, FIG. 2 through FIG. 14.

As shown in FIG. 2, the pipe 10 has an outer diameter OD and an inner diameter ID. The outer diameter OD of the pipe 10 is determined by the size of the pipe 10. The inner diameter ID of the pipe 10 is determined by the schedule of the pipe 10.

Generally, the disc body 38 is sized such that an outer diameter OD1, shown in FIG. 7, of the disc body 38 is approximately the same as the OD of the pipe 10. “Approximately” generally means within +/−5% to 10% of the value.

In some implementations, the outer diameter OD1 of the outer ring 58 is the same size as the outer diameter OD of the pipe 10. In some implementations, the outer diameter OD1 is larger than the OD of the pipe 10 such that the outer ring 58 extends outside the pipe 10. In some implementations, the outer diameter OD1 is the same size as the inner diameter ID of the pipe 10 such that the entire disc body 38 fits inside the pipe 10.

Generally, the disc body 38 is sized such that an inner diameter ID1, shown in FIG. 7, of the disc body 38 is approximately the same as the ID of the pipe 10. In some implementations, the inner diameter ID1 of the outer ring 58 is the same size as the inner diameter ID of the pipe 10. In some implementations, the inner diameter ID1 is smaller than the inner diameter ID of the pipe 10.

The disc body 38 includes a first side 50 and a second side 54. The first side 50 defines a first surface, and the second side 54 defines a second surface. In some implementations, the disc body 38 is positioned in the pipe 10 such that the fluid flows from the first side 50 to the second side 54 of the disc body 38. In other implementations, the first side 50 may face the direction of flow and the second side 54 may face the opposite direction.

The disc body 38 is formed from a flexible material. The disc body 38 may be formed from a polyimide material or a silicone polymer material. More specifically, the disc body 38 may be formed from Polydimethylsiloxane (PDMS). In some implementations, the disc body 38 may be formed from Polytetrafluoroethylene (PTFE).

The disc body 38 has a symmetrical shape. The disc body 38 has at least two lines of symmetry and 180 degrees of rotational symmetry. In some implementations, the disc body 38 may have more lines of symmetry and may have 90 degrees of rotational symmetry. In some implementations, the disc body 38 may have one line of symmetry and 360 degrees of rotational symmetry. In some implementations, the disc body 38 may not be symmetrical.

The disc body 38 has a height of H1 (FIG. 10). The height H1 of the disc body 38 may be consistent throughout the disc body 38. In some implementations, the disc body 38 may have a varying height and H1 is the maximum height.

### C. Exemplary Parts of the Disc Body

The disc body 38 defines an outer ring 58, a beam 62, a first flap 66, a second flap 70, a first flow opening 74, and a second flow opening 78. Various aspects of each are discussed below.

The outer ring 58 engages an end of the pipe 10 or a junction of the pipe 10. The outer ring 58 supports the disc body 38 adjacent the end of the pipe 10 or at the junction of the pipe 10.

With reference to FIG. 7, the outer ring 58 has a and has a width of W1. The width W1 of the outer ring 58 may be the same as the schedule (e.g., the thickness of the pipe walls) as the pipe 10. In some implementations, the width W1 of the outer ring 58 is greater than the schedule of the pipe 10.

With reference to FIG. 10, the outer ring 58 has a height of H1. In some implementations, the outer ring 58 may have a height that is smaller or larger than the height H1 of the disc body 38.

The beam 62 extends across the outer ring 58. The beam 62 supports the multi-directional strain sensor 42 and supports a frame 34. In some instances, beam 62 defines a cavity 90. The beam 62 is operable to flex or bend in a first direction (e.g., the direction of flow), a second direction (e.g., the direction perpendicular to the flow), and a third direction (e.g., the direction opposite the flow) when fluid is flowing through the flow sensor disc 14 and pushes on the disc body 38.

With reference to FIG. 8, the beam 62 has a generally rectangular cross-sectional shape. The beam 62 has a length of L1 and a width of W2. The length L1 of the beam 62 is larger than the width W2 of the beam 62. The beam 62 has a height of H1. In some implementations, the beam 62 may have a height that is smaller or larger than the height H1 of the disc body 38.

When the flow sensor disc 14 is positioned adjacent the pipe 10, the length L1 of the beam 62 extends vertically across the pipe 10. In some implementations, when the flow sensor disc 14 is positioned within the pipe 10, the length L1 of the beam 62 may extend horizontally across the pipe 10. In some implementations, when the flow sensor disc 14 is positioned within the pipe 10, the length L1 of the beam 62 may extend diagonally across the pipe 10.

With reference to FIG. 5, the frame 82 is disposed on the beam 62. Generally, the frame 82 defines a volume that houses the multi-directional strain sensor 42. As shown, the frame 82 extends above the disc body 38 and the beam 62 to generate a reservoir 86 that holds and supports the multi-directional strain sensor 42.

With reference to FIGS. 8 and 10, the frame 82 has a rectangular shape. The frame 82 extends along the length L1 of the beam 62. In some implantations, the frame 82 may extend perpendicular to the length L1 of the beam 62 such that the frame 82 is supported by the first flap 66, the beam 62, and the second flap 70 (not shown in the figures). In some implementations, the frame 82 may be formed in a different shape (e.g., triangular, hexagonal, etc.).

With continued reference to FIGS. 8 and 10, the frame 82 has a length of L2, a width of W3, a wall thickness of T1, and a height of H2. The frame 82 is smaller than the beam 62 such that the length L2 of the frame 82 is less than the length L1 of the beam 62 and the width W3 of the frame 82 is less than the width W2 of the beam 62. The height H2 of the frame 82 is smaller than the height H1 of the disc body 38.

The cavity 90 is a cavity disposed in the beam 62 and is configured to hold an air gap (discussed below in detail). In the embodiment shown, the cavity 90 is disposed at the center of the beam 62 and at the center of the disc body 38. The cavity 90 extends from the first side 50 toward the second side 54. In some implementations, the cavity 90 may be positioned off-center of the beam 62 and the disc body 38. In some implementations, the disc body 38 does not include a cavity 90.

In the embodiment shown in FIG. 8 and FIG. 10, the cavity 90 is a cylindrical cavity. The cavity 90 has a diameter of OD2 and a depth of H3. The diameter OD2 is smaller than the width W3 of the frame 82 and the width of the W2 of the beam 62. The depth H3 is measured from the first side 50 to the bottom of the cavity 90. The depth H3 is less than the height H1 of the disc body 38. In some implications, the cavity 90 has a different shape (e.g., a prismatic shape).

With refence to FIG. 4 and FIG. 5, the first flap 66 extends from a first side of the beam 62 toward the outer ring 58. The first flap 66 is configured to flex or bend in the first direction and in the second direction when fluid is flowing through the flow sensor disc 14.

The first flap 66 has an arcuate cross-sectional shape. More specifically, the first flap 66 has a near semi-circular cross-sectional shape. In some instances, the first flap 66 has a cross-sectional shape that is 50%-60% of a semi-circle. In some implementations, the first flap 66 has a semi-circle cross-sectional shape.

With reference to FIG. 9, the first flap 66 has a length of L3, a maximum width of W4, and an arc angle of A1. The length L3 is less than the length L2 of the frame 82 and L1 of the beam 62. The maximum width W4 is defined at the center of the first flap 66 and is the widest part of the first flap 66. The first flap 66 has a height of H1. In some implementations, the first flap 66 may have a height that is smaller or larger than the height H1 of the disc body 38.

With refence to FIG. 4 and FIG. 5, the second flap 70 extends from a second side of the beam 62 toward the outer ring 58. The second side of the beam 62 is opposite the first side of the beam 62. The second flap 70 is configured to flex or bend in the first direction and in the second direction when fluid is flowing through the flow sensor disc 14.

In the embodiment shown, the second flap 70 is symmetrical with the first flap 66 such that the second flap 70 has an arc shape, a length L3, a maximum width W4, and an arc angle A1. In some implementations, the second flap 70 larger or smaller than the first flap 66. In some implementations, the second flap 70 is a different shape than the first flap 66.

With reference to FIGS. 4-6, the first flow opening 74 is defined between the outer ring 58 and the first flap 66 and extends through the disc body 38. The first flow opening 74 allows fluid to flow through the flow sensor disc 14 as the first flap 66 is flexed or bent.

The first flow opening 74 has an arc shape. More specifically, the first flow opening 74 has a near semi-circular shape. The first flow opening 74 has a shape that is 65%-75% of a semi-circle. The shape of the first flow opening 74 is defined by the first flap 66. In some implementations, the first flow opening 74 is a semi-circle.

With reference to FIG. 9, the first flow opening 74 has a length of L4, a width of W5, and an arc angle of A2. The length L4 is more than the length L3 of the first flap 66.

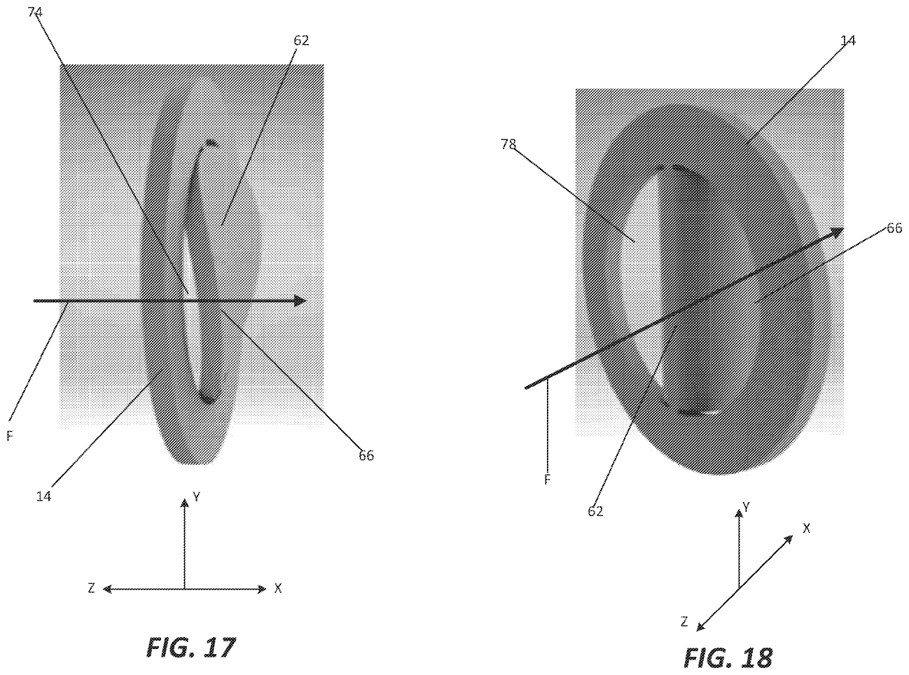

The width W5 is defined when the first flow opening 74 is at a resting position and the first flap 66 is not bent or flexed. The width W5 of the first flow opening 74 is configured to change as the first flap 66 flexes in different directions. For example, the width W5 of the first flow opening 74 is larger when the first flap 66 is flexed in the first direction (as shown in FIG. 17) than when the first flap 66 is at a neural, resting position (as shown in FIG. 9).

In some implementations, the width W5 is minimal such that the first flap 66 abuts the outer ring 58 when the disc body 38 is in the resting position. In this implementation, the first flow opening 74 is merely a slit or a cut between the first flap 66 and the outer ring 58 when the disc body 38 is in the resting position.

The second flow opening 78 is positioned between the outer ring 58 and the second flap 70. The second flow opening 78 extends through the disc body 38. The second flow opening 78 allows fluid to flow through the flow sensor disc 14.

The second flow opening 78 is symmetrical with the first flow opening 74 such that the second flow opening 78 has an arc shape, a length of L4, a width of W5, and an are angle of A2. In some implementations, the second flow opening 78 is larger or smaller than the first flow opening 74. In some implementations, the second flow opening 78 is a different shape than the first flow opening 74.

FIG. 15 is a front plan view of the flow sensor disc 14 of FIG. 3. FIG. 16 is a section view of the flow sensor disc 14 of FIG. 3.

With reference to FIG. 15 and FIG. 16, the multi-directional strain sensor 42 is configured to generate data related to the strain in the disc body 38 as the beam 62, the first flap 66 and the second flap 70 are flexed.

The multi-directional strain sensor 42 is supported by the disc body 38. As discussed in greater detail below, during an exemplary method of making, the multi-directional strain sensor 42 may be deposited in the reservoir 86 of the frame 82.

With reference to FIGS. 15 and 16, the reservoir 86 and the frame 82 shape the multi-directional strain sensor 42 such that the sensor 42 has a rectangular shape with four corners. The multi-directional strain sensor 42 has a length of L5, a width of W6, and a maximum thickness T2. The length L5 and the width W6 of the sensor may be similar or less than the length L2 and width W3 of the frame 82. The thickness T2 of the multi-directional strain sensor 42 is less than the height H2 of the frame 82.

With reference to FIG. 16, the flow sensor disc 14 may include an air gap 102 disposed in the cavity 90. The air gap 102 is situated between a first layer 100a of material and a second layer 100b of material. The material in first layer 100a and/or 100b may be a polyimide material or a silicone polymer material. The air gap 102 may increase the flexibility of beam 62 such that the flow sensor disc 14 can measure the pressure of the fluid in the pipe 10.

The flow sensor disc 14 further includes a sealing layer (not shown) disposed on the disc body 38. More specifically, the sealing layer is disposed on the surface of the multi-directional strain sensor 42. The sealing layer is a barrier between the multi-directional strain sensor 42 and the fluid in the pipe 10. The sealing layer may be a thin layer of PDMS or a different hydrophobic material. In some implementations, the sealing layer is applied on the entire disc body 38. In some implementations, the sealing layer is applied on the entire surface of the first side 50.

### D. Exemplary Dimensional Ratios

With reference to FIGS. 7-11, 14, and 16, possible ratios between different structures of the flow sensor disc 14 will be described in detail below.

The ratio between the outer diameter OD1 of the outer ring 58 and the inner diameter ID1 of the outer ring 58 may be 1.45. In other instances, the ratio is slightly more or slightly less than 1.45. As one example, the ratio is no less than 1.19 and no greater than 1.77. As another example, the ratio is no less than 1.25 and no greater than 1.77. As another example, the ratio is no less than 1.19 and no greater than 1.65.

The ratio between the outer diameter OD1 of the outer ring 58 and the width W2 of the beam 62 may be 3. In other instances, the ratio is slightly more or slightly less than 3. As one example, the ratio is no less than 2.45 and no greater than 3.67. As another example, the ratio is no less than 2.7 and no greater than 3.67. As another example, the ratio is no less than 2.45 and no greater than 3.3.

The ratio between the width W2 of the beam 62 and the width W3 of the frame 82 may be 1.25. In other instances, the ratio is slightly more or slightly less than 1.25. As one example, the ratio is no less than 1.02 and no greater than 1.53. As another example, the ratio is no less than 1.1 and no greater than 1.53. As another example, the ratio is no less than 1.02 and no greater than 1.35.

The ratio between the width W2 of the beam 62 and the maximum width W4 of the first flap 66 and the second flap 70 may be 3. In other instances, the ratio is slightly more or slightly less than 3. As one example, the ratio is no less than 2.45 and no greater than 3.67. As another example, the ratio is no less than 2.7 and no greater than 3.67. As another example, the ratio is no less than 2.45 and no greater than 3.3.

The ratio between the width W1 of the outer ring 58 and the width W5 of the first flow opening 74 and the second flow opening 78 may be 2. In other instances, the ratio is slightly more or slightly less than 2. As one example, the ratio is no less than 1.91 and no greater than 2.85. As another example, the ratio is no less than 1.95 and no greater than 2.85. As another example, the ratio is no less than 1.91 and no greater than 2.5.

The ratio between the height H1 of the disc body 38 and the thickness T2 of the senor may be 300. In other instances, the ratio is slightly more or slightly less than 300. As one example, the ratio is no less than 100 and no greater than 568. As another example, the ratio is no less than 200 and no greater than 568. As another example, the ratio is no less than 100 and no greater than 400.

The ratio between the width W2 of the beam 62 and the width W6 of the multi-directional strain sensor 42 may be 1.25 In other instances, the ratio is slightly more or slightly less than 1.25. As one example, the ratio is no less than 1.02 and no greater than 1.53. As another example, the ratio is no less than 1.1 and no greater than 1.53. As another example, the ratio is no less than 1.02 and no greater than 1.35.

### E. Exemplary Dimensions

In an exemplary embodiment, the flow sensor disc 14 may be sized to fit a 15 mm pipe. With reference to FIGS. 7-11, 14, and 16, measurements of the exemplary flow sensor disc 14 for a 15 mm pipe are described below in detail.

The height H1 of the disc body 38 for the 15 mm pipe embodiment may be 0.25 cm. In other instances, the height H1 is slightly more or slightly less than 0.25 cm. As one example, the height H1 is no less than 0.2 cm and no greater than 0.3 cm. As another example, the height H1 is no less than 0.225 cm and no greater than 0.3 cm. As another example, the height H1 is no less than 0.25 cm and no greater than 0.28 cm.

The outer diameter OD1 of the outer ring 58 for the 15 mm pipe embodiment may be 2.28 cm. In other instances, the outer diameter OD1 is slightly more or slightly less than 2.28 cm. As one example, the outer diameter OD1 is no less than 2.0 cm and no greater than 2.5 cm. As another example, the outer diameter OD1 is no less than 2.1 cm and no greater than 2.5 cm. As another example, the outer diameter OD1 is no less than 2.0 cm and no greater than 2.35 cm.

The inner diameter ID1 of the outer ring 58 for the 15 mm pipe embodiment may be 1.57 cm. In other instances, the inner diameter ID1 is slightly more or slightly less than 1.57 cm. As one example, the inner diameter ID1 is no less than 1.00 cm and no greater than 2.00 cm. As another example, the inner diameter ID1 is no less than 1.3 cm and no greater than 2.00 cm. As another example, the inner diameter ID1 is no less than 1.00 cm and no greater than 1.75 cm.

The width W1 of the outer ring 58 for the 15 mm pipe embodiment may be 0.36 cm. In other instances, the width W1 is slightly more or slightly less than 0.36 cm. As one example, the width W1 is no less than 0.25 cm and no greater than 0.45 cm. As another example, the width W1 is no less than 0.3 cm and no greater than 0.45 cm. As another example, the width W1 is no less than 0.25 cm and no greater than 0.4 cm.

The length L1 of the beam 62 for the 15 mm pipe embodiment may be 1.57 cm. In other instances, the length L1 is slightly more or slightly less than 1.57 cm. As one example, the length L1 is no less than 1.00 cm and no greater than 2.00 cm. As another example, the length L1 is no less than 1.3 cm and no greater than 2.00 cm. As another example, the length L1 is no less than 1.00 cm and no greater than 1.5 cm.

The width W3 of the beam 62 for the 15 mm pipe embodiment may be 0.76 cm. In other instances, the width W3 is slightly more or slightly less than 0.76 cm. As one example, the width W3 is no less than 0.5 cm and no greater than 1.0 cm. As another example, the width W3 is no less than 0.65 cm and no greater than 1.0 cm. As another example, the width W3 is no less than 0.5 cm and no greater than 0.85 cm.

The width W3 of the frame 82 outer ring 58 for the 15 mm pipe embodiment may be 0.61 cm. In other instances, the width W3 is slightly more or slightly less than 0.61 cm. As one example, the width W3 is no less than 0.5 cm and no greater than 1.0 cm. As another example, the width W3 is no less than 0.55 cm and no greater than 1.0 cm. As another example, the width W3 is no less than 0.5 cm and no greater than 1.75 cm.

The length L3 of the frame 82 for the 15 mm pipe embodiment may be 1.22 cm. In other instances, the length L3 is slightly more or slightly less than 1.22 cm. As one example, the length L3 is no less than 1 cm and no greater than 1.5 cm. As another example, the length L3 is no less than 1.10 cm and no greater than 1.5 cm. As another example, the length L3 is no less than 1 cm and no greater than 1.4 cm.

The thickness T1 of the frame 82 for the 15 mm pipe embodiment may be 0.058 cm. In other instances, the thickness T1 is slightly more or slightly less than 0.058 cm. As one example, the thickness T1 is no less than 0.025 cm and no greater than 0.10 cm. As another example, the thickness T1 is no less than 0.03 and no greater than 0.10 cm. As another example, the thickness T1 is no less than 0.025 cm and no greater than 0.75 cm.

The height H2 of the frame 82 for the 15 mm pipe embodiment may be 0.10 cm. In other instances, the height H2 is slightly more or slightly less than 0.10 cm. As one example, the height H2 is no less than 0.05 cm and no greater than 0.15 cm. As another example, the height H2 is no less than 0.08 cm and no greater than 0.15 cm. As another example, the height H2 is no less than 0.05 cm and no greater than 0.13 cm.

The outer diameter OD2 of the cavity 90 for the 15 mm pipe embodiment may be 0.37 cm. In other instances, the outer diameter OD2 is slightly more or slightly less than 0.37 cm. As one example, the outer diameter OD2 is no less than 0.25 cm and no greater than 0.45 cm. As another example, the outer diameter OD2 is no less than 0.30 cm and no greater than 0.45 cm. As another example, the outer diameter OD2 is no less than 0.25 cm and no greater than 0.40 cm.

The height H3 of the cavity 90 for the 15 mm pipe embodiment may be 0.20 cm. In other instances, the height H3 is slightly more or slightly less than 0.20 cm. As one example, the height H3 is no less than 0.10 cm and no greater than 0.30 cm. As another example, the height H3 is no less than 0.15 cm and no greater than 0.30 cm. As another example, the height H3 is no less than 0.10 cm and no greater than 0.25 cm.

The maximum width W4 of the first flap 66 and the second flap 70 for the 15 mm pipe embodiment may be 0.254 cm. In other instances, the maximum width W4 is slightly more or slightly less than 0.254 cm. As one example, the maximum width W4 is no less than 0.2 cm and no greater than 0.3 cm. As another example, the maximum width W4 is no less than 0.23 cm and no greater than 0.3 cm. As another example, the maximum width W4 is no less than 0.2 cm and no greater than 0.28 cm.

The length L3 of the first flap 66 and the second flap 70 for the 15 mm pipe embodiment may be 0.97 cm. In other instances, the length L3 is slightly more or slightly less than 0.97 cm. As one example, the length L3 is no less than 0.9 cm and no greater than 1.3 cm. As another example, the length L3 is no less than 0.95 cm and no greater than 1.3 cm. As another example, the length L3 is no less than 0.9 cm and no greater than 1.1 cm.

The arc angle A1 of the first flap 66 and the second flap 70 for the 15 mm pipe embodiment may be 110 degrees. In other instances, the arc angle A1 is slightly more or slightly less than 110 degrees. As one example, the arc angle A1 is no less than 100 degrees and no greater than 120 degrees. As another example, the arc angle A1 is no less than 105 degrees and no greater than 120 degrees. As another example, the arc angle A1 is no less than 100 degrees and no greater than 115 degrees.

The width W5 of the first flow opening 74 and the second flow opening 78 for the 15 mm pipe embodiment when the disc body 38 is in the resting position may be 0.305. In other instances, the width W5 is slightly more or slightly less than 0.305 cm. As one example, the width W5 is no less than 0.01 cm and no greater than 0.5 cm. As another example, the width W5 is no less than 0.15 cm and no greater than 0.5 cm. As another example, the width W5 is no less than 0.01 cm and no greater than 0.4 cm.

The length L4 of the first flow opening 74 and the second flow opening 78 for the 15 mm pipe embodiment may be 1.57 cm. In other instances, the length L4 is slightly more or slightly less than 1.57 cm. As one example, the length L4 is no less than 1 cm and no greater than 2 cm. As another example, the length L4 is no less than 1.3 cm and no greater than 2 cm. As another example, the length L4 is no less than 1 cm and no greater than 1.75 cm.

The arc angle A2 of the first flow opening 74 and the second flow opening 78 for the 15 mm pipe embodiment may be 117 degrees. In other instances, the arc angle A2 is slightly more or slightly less than 117 degrees. As one example, the are angle A2 is no less than 110 degrees and no greater than 125 degrees. As another example, the arc angle A2 is no less than 112 degrees and no greater than 125. As another example, the arc angle a2 is no less than 110 degrees and no greater than 120 degrees.

The length L5 of the multi-directional strain sensor 42 for the 15 mm pipe embodiment may be 1.22 cm. In other instances, the length L5 is slightly more or slightly less than 1.22 cm. As one example, the length L5 is no less than 1.00 cm and no greater than 1.5 cm. As another example, the length L5 is no less than 1.15 cm and no greater than 1.5 cm. As another example, the length L5 is no less than 1.00 cm and no greater than 1.3 cm.

The width W6 of the multi-directional strain sensor 42 for the 15 mm pipe embodiment may be 0.61 cm. In other instances, the width W6 is slightly more or slightly less than 0.61 cm. As one example, the width W6 is no less than 0.5 cm and no greater than 1 cm. As another example, the width W6 is no less than 0.55 cm and no greater than 1 cm. As another example, the width W6 is no less than 0.5 cm and no greater than 0.75 cm.

The maximum thickness T2 of the multi-directional strain sensor 42 for the 15 mm pipe embodiment may be 19 μm. In other instances, the maximum thickness T2 is slightly more or slightly less than 19 μm. As one example, the thickness T2 is no less than 15 μm and no greater than 30 μm. As another example, the thickness T2 is no less than 18 μm and no greater than 30 μm. As another example, the thickness T2 is no less than 15 μm and no greater than 25 μm.

### F. Exemplary Flow Sensor Disc Behavior in Various Flow Regimes

FIG. 17 is a side view of a flow sensor disc 14 of FIG. 3 in a low-flow regime. In the low-flow regime, the beam 62, the first flap 66, and the second flap 70 are configured to flex and bend as the fluid flows through the first flow opening 74 and the second flow opening 78. The first flap 66 and the second flap 70 flex in a first direction X. The first direction X is in the direction of the flow F. The beam 62 flexes in the first direction and in the second direction Y. The second direction Y is perpendicular to the first direction X.

Said another way, in the low-flow regime, the beam 62, the first flap 66, and the second flap 70 flex to form a hyperbolic paraboloid that is perpendicular to the flow. The hyperbolic paraboloid increases the width of the first flow opening 74 and the second flow opening 78.

FIG. 18 is a side perspective view of a flow sensor disc 14 of FIG. 3 in a non low-flow regime. In the non low-flow regime, the first flap 66, and the second flap 70 are configured to flex and bend as the fluid flows through the first flow opening 74 and the second flow opening 78. The beam 62 is configured to not flex during the non low-flow regime. The first flap 66 and the second flap 70 flex in the first direction.

Said another way, in the non-low-flow regime, the beam 62, the first flap 66, and the second flap 70 create a semi-circular canal with a flat bottom that is perpendicular to the flow. The semi-circular canal increases the width of the first flow opening 74 and the second flow opening 78. The width of the first flow opening 74 and the second flow opening 78 is larger in the non low-regime than in the low-regime.

Additionally, the beam 62, the first flap 66, and the second flap 70 are operable to flex in a third direction Z. The third direction Z is opposite the flow direction and the first direction X. The beam 62, first flap 66, and second flap 70 flex in the third direction Z when there is no flow, and the flow sensor disc body 38 returns to a resting position.

### G. Exemplary Molds

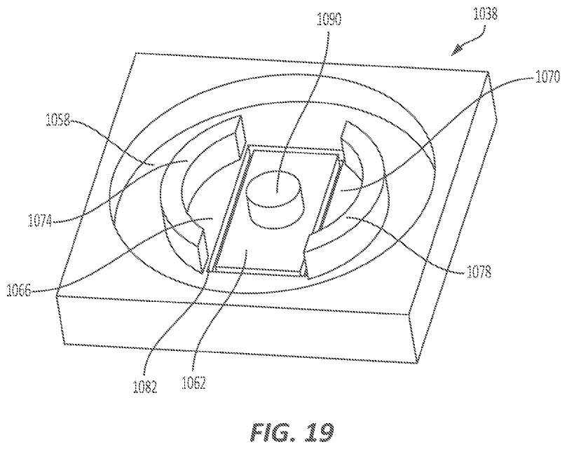

FIG. 19 is a front perspective view of an exemplary mold 1038. The mold 1038 may be used to shape and form the disc body 38 and create an integrally formed disc body 38. The mold 1038 includes structures that correspond to the structures of the disc body 38.

The mold 1038 includes a recessed outer ring 1058 that defines the outer ring 58 of the disc body 38. The mold includes a recessed beam 1062 that extends across the recessed outer ring 1058 to define the beam 62 of the disc body 38.

The recessed beam 1062 may include a recessed frame 1082 and a protruding cylinder 1090. The recessed frame 1082 of the recessed beam 1062 defines the frame 82, and the protruding cylinder 1090 defines the cavity 90.

The mold 1038 also includes a first arc shaped recess 1066 and a second arc shaped recess 1070 that define the first flap 66 and the second flap 70. The mold also includes a first arc shaped protrusion 1074 that defines the first flow opening 74 and a second arc shaped protrusion 1078 that defines the second flow opening 78.

In some implementations, not shown, the mold 1038 does not include a first arc shaped protrusion 1074 and a second arc shaped protrusion 1078 that define the first flow opening 74 and the second flow opening 78. In this implementation, the first flow opening 74 and the second flow opening 78 are formed by cutting through the disc body 38 between the outer ring and the first flap 66 and the second flap 70 such that the first flap 66 and the second flap 70 can flex relative to the disc body 38. This implementation limits the distance between the outer ring 58 and the flaps 66, 70.

### H. Exemplary Computing Systems

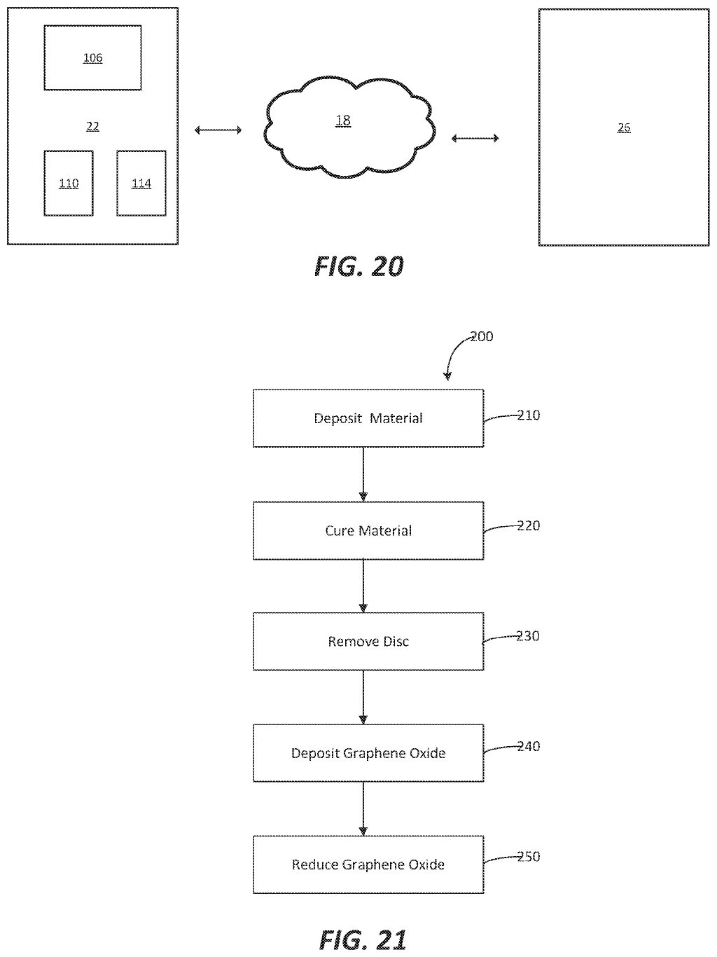

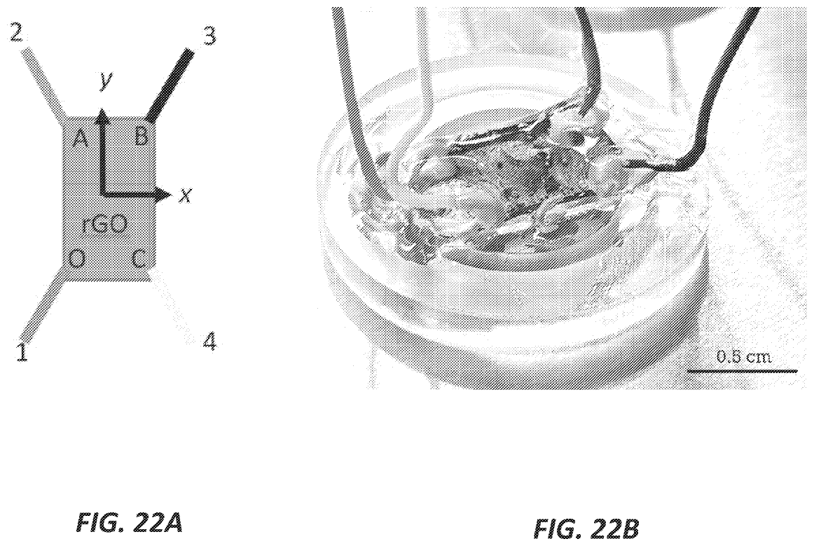

FIG. 20 is a schematic of the computing system of the flow sensor disc according to some embodiments. The computing system includes the computing unit 22, the network 18, and the user device 26. The computing unit 22 may communicate with the user device 26 via network 18.

The computing unit 22 is electrically connected to the flow sensor disc 14 and processes data from the flow sensor disc 14. The computing unit 22 may be electrically connected to the flow sensor disc 14 with the wires 46 or it may be wirelessly connected to the flow sensor disc 14.

The computing unit 22 may include a data collector 106, a processor 110, and a memory 114. The computing unit 22 may also include a power supply that powers the computing unit 22. In some implementations, the data collector 106, the processor 110, and the memory 114 are in different devices that are electrically connected to each other. In some implementations, the data collector 106, the processor 110, and the memory 114 are in the same device.

The data collector 106 is operable to receive data from the flow sensor disc 14. More specifically, the data collector 106 is operable to receive the electrical resistance from the wires 46 of the flow sensor disc 14. The data collector 106 may be an oscilloscope.

A data analyzer software module stored in memory 114 is operable to process the data from the data collector 106. More specifically, the data analyzer processes the electrical resistance data from the data collector 106 and converts the electrical resistance data into information about the strain in the flow sensor disc and the flowrate of the fluid in the pipe 10. The processor 110 may be an Arduino board.

The memory 114 is operable to store information received from the flow sensor disc 14. The memory 114 is operable to store past flowrates in the pipe 10. The memory 114 may also store flowrate thresholds.

The user device 26 may be a display, a computer, or a cell phone. The user device 26 receives the flow information from the computing unit 22. The user device 26 allows the user to review information about the flow in the pipe 10.

If the computing unit 22 determines a leak condition exists, it may send a signal to the user device 26 to alert the user of the leak or a low flow. The computing unit 22 may send data regarding an amount of fluid flow and/or fluid flowrate during given time period.

### III. Exemplary Methods

Exemplary methods of manufacturing a flow sensor and of using a flow sensor are discussed below.

### A. Exemplary Methods of Making

FIG. 21 shows an example method 200 for making a flow sensor system 5. Other implementations of making a flow sensor system can include more or fewer operations than those shown in FIG. 21. In some implementations, the operations of the method 200 may be performed in a different order.

The example method 200 begins by depositing a material into the mold 1038 (operation 210). The material may be a polyimide material or a silicone polymer material.

After depositing the material into the mold 1038, the material is cured to form the disc body 38 (operation 220). The material may be cured in a room temperature room (e.g., at a cure temperature of 23-30° C.) for a cure time of at least 48 hours; at least 60 hours; or at least 72 hours. In some implementations, the cure temperature may be greater than 30° C. and the cure time may be decreased.

After the material is cured (operation 220), the disc body 38 may be removed from the mold 1038 (operation 230). In some instances, the disc body 38 may be cut from the mold 1038. The disc body 38 may be washed and dried to remove any residue.

After the disc body 38 is removed from the mold 1038 (operation 230), the disc body 38 may be prepared to receive the multi-directional strain sensor 42. The disc body 38 may be prepared by plasma etching the disc body 38 and immersing the disc body 38 into a medium.

The disc body 38 may be plasma etched for at least three minutes. In some implementations the disc body may be plasma etched for more or less time.

The disc body 38 may immersed in a medium for a predetermined amount of time. In some instances, the predetermined amount of time is no less than 1 hour and no greater than 4 hours. In various implementations, the predetermined amount of time may be no less than 1 hour; no less than 2 hours; no less than 3 hours; or no less than 4 hours. The disc body 38 may be immersed for 3 hours.

The medium may comprise ethanol. More specifically, the medium may contain 98 parts ethanol and 2 parts (3-Aminopropyl)triethoxysilane.

After the disc body 38 is prepared, the air gap 102 in the cavity 90 may be generated. To create the air gap 102 a first layer 100a of material is disposed on the base of the cavity 90 and is cured. Then, a second layer 100b of material is disposed on the base of the cavity 90 and the disc body 38 is flipped such that the second layer 100b of material moves to the top of the cavity 90. The second layer 100b is cured in this position such that the air gap forms between the first layer 100a and the second layer 100b of material. Various types of silicone polymer material or polyimide material may be used for layers 100a and 100b.

After the air gap 102 is generated, the multi-directional strain sensor 42 may be placed on the disc body 38. More specifically, graphene oxide is deposited on into the frame 82 of the disc body 38 (operation 240). The graphene oxide is deposited in the reservoir 86 defined by the frame 82. The graphene oxide may be drop casted using a pipette. In some instances, the graphene oxide may be ink jet printed or sputter coated. After the graphene oxide is deposited, the graphene oxide is dried for at least 24 hours.

Next, the graphene oxide is reduced (operation 250). Reducing the graphene oxide generates the multi-directional strain sensor 42. The graphene oxide may be thermally reduced. More specifically, the graphene oxide may be reduced by first raising the temperature from room temperature to 180° C. in 60 minutes. Then, the temperature may be kept at 180 degrees for 60 minutes and then increased to 200° C. in 5 minutes. The temperature may then be kept at 200° C. for 5 minutes before the temperature is bought back down to room temperature in 90 minutes. In some implementations, different temperatures and times may be used to reduce the graphene oxide.

After the graphene oxide is reduced (operation 210) and the multi-directional strain sensor 42 is generated, at least two wires 46 are attached to the multi-directional strain sensor 42. In some implementations, four wires 46 are attached to the multi-directional strain sensor 42. The wires 46 are attached adjacent to the corners of the multi-directional strain sensor 42. The wires 46 may be secured to the multi-directional strain sensor 42 with an epoxy 98.

Once the wires 46 are attached, a seal layer may be applied to at least a surface of the multi-directional strain sensor 42. In some implementations, the seal layer is applied to the surface of the first side 50 of the disc body 38. In some implementations, the entire disc body 38 is sealed.

Once the multi-directional strain sensor 42 is sealed, the flow sensor disc 14, specifically the wires 46, may be electrically connected to the computing unit 22 and may be positioned in the pipe 10. Electrically connecting the wires 46 to the computing unit 22 allows the computing unit 22 to receive signals from the wires 46 to determine a flow condition and/or a pressure condition of the fluid in the pipe.

### B. Exemplary Methods of Using

An exemplary method of using a flow sensor disc may include various operations. For instance, the flow sensor disc may be positioned in a pipe and connected (wired or wirelessly) to a computing unit.

During a low-flow regime, the first flap 66, and the second flap 70 flex in the first direction X, and the beam 62 flexes in the first direction X and the second direction Y. The multi-directional strain sensor 42 generates data about how the beam 62, first flap 66, and second flap 70, are flexing. The computing unit 22 receives the data and processes the data. Typically, computing unit 22 quantifies a fluid flowrate and/or pressure condition in the pipe. The computing unit 22 may send a signal to the user device 26 via the network 18 to alert the user of a leak in the pipe 10.

During a non low-flow regime, the first flap 66 and the second flap 70 flex in the first direction X, and the beam 62 does not flex. The multi-directional strain sensor 42 generates data about the amount the beam 62, first flap 66, and second flap 70, are flexing. The computing unit 22 receives the data and processes the data. Typically, computing unit 22 quantifies a fluid flowrate and/or pressure condition in the pipe. The computing unit 22 may sends a signal to the user device 26 via the network 18 to provide the user with the flowrate of the fluid and to provide the fluid usage amount for a period of time.

### IV. Experimental Examples

Various experiments were conducted and the results are discussed below.

### A. Materials and Synthesis

A sensor body was made of PDMS and reduced graphene oxide (rGO) was used as the sensing element. 186 Silicone Elastomer (PDMS) was used to make the body of the sensor. First the PDMS was cast into the molds. To remove the bubbles from the PDMS, it was placed in a vacuum chamber for 80 min and then cast into molds. Molds were made of polycarbonate material and designed by Creo CAD software and prototyped by 3D printer first. After the dimensions, sizes and design were established, the final mold's designs were sent to the University of Wisconsin Milwaukee's Machine Shop to be machined for quality improvement of the resulting specimens. After the SYLGARD 186 Silicone Elastomer was cast into the molds, it was cured at room temperature for 3 days. After the cured body of the sensor was cut out of the mold, it was washed completely by deionized water and dried by compressed air. To enhance the adhesion of the substrate it was placed in a PE-25 plasma etching machine for 5 minutes. Then it was immersed in a solution of 2 part (3-Aminopropyl)triethoxysilane and 98 parts Ethanol for 3 hours.

To prepare the GO (Graphenea 0.4 wt % GO dispersion) solution for drop casting, it was agitated in a Cole Parmer ultrasonic cleaner (M-series) for 2 minutes. Then 0.1282 ml of the solution was drop cast on to the reservoir of the body of the sensor with the area of 6.096 mm by 12.192 mm to make 0.0069 mg/mm² area density of GO on the body of the sensor. Then it was kept in the hood at room temperature to be dried for 24 hours. After being dried, thermal reduction was performed on the Sensor. It was placed in the OTF-1200 Series Split Tube Furnaces in the presence of Argon gas. In the thermal reduction process, temperature was raised to 180° C. from room temperature in 60 min and kept at the same temperature in 60 min. Again, increased to 200° C. in 5 min and kept at the same temperature for 10 min. Finally brought back to the room temperature in 90 min. The temperature was ramped up and down to reach the targeted temperature. After the thermal reduction process, 4 electrodes were added by the conductive epoxy to the sensor like FIG. 4-3. To measure resistance the same circuit and equation as for the tensile tests were used. Sensor was designed to fit in a 12.7 mm (½ inch) diameter pipe. An air void was designed later inside the sensor for pressure sensing which was not visible from the outside.

### B. Testing

Flowrates were varied to investigate the resistive response of the sensor. The test was performed at 137.895 kPa (20 psi) pressure. The sensor was placed in a coupling between two pipes with 12.7 mm (½ inch) diameters. The distance between electrodes on the sensor in x, y and at the angle directions were 0.61 mm, 6.37 mm, and 7.16 mm. In addition, the sensitivity and resolution of the sensor were measured. Pressure regulator and pressure gauges were used to reduce and measure the pressure 137.895 kPa (20 psi) respectively. Arduino Uno was used to supply excitation electrical energy for the data acquisition circuit.

Pressure drop was evaluated on the initial design in the sensor to determine the amount of pressure drop that happened when the sensor was in the pipe. It was tested in a 45.72 cm long pipe. The sensor was placed in a coupling between two pipes with 12.7 mm (½ inch) diameters.

A sample with the same geometry and size that was used for imaging with the area density of 0.0069 mg/mm2 was tested under constant strain for creep. Sample was tested over time under 0%, 7.57% and 10.59% strains using the same tensioning device that was made using 3D-printer. The distance between electrodes in the x direction was 1.43 mm. Testing was performed at room temperature.

Fatigue test was performed on the sensor with 0.0069 mg/mm² area density by application of cyclic loading with 10 seconds of on-cycles with the average of 2496.871 ml/min flowrate and 10 seconds of off-cycles with zero ml/min of flowrate. The “on” and “off” cycles were created using a solenoid valve and a timer. The flowrate was adjusted by a needle valve. Pressure was adjusted by a pressure reducer to 34.4738 kPa (5 psi) pressure. Distances between electrodes in x, y and the oblique directions were measured as 1.37 mm, 7.28 mm, and 7.4 mm respectively. The same data acquisition system as tensile experiments were used with the same electrical bridges, oscilloscope and Arduino Uno (as a power supply). Temperature was kept in a constant range with the average of 22.72° C. using a water heater to avoid effects of temperature variation on the resistive response of the sensor.

The sensor with 0.0069 mg/mm² and distances between electrodes of 0.88 mm, 6.85 mm, 7.81 mm in the x, y and the oblique directions respectively was tested at high flowrates up to 32035.83 ml/min. Test was performed at the average pressure and temperature of 227.52 kPa (33 psi) and 20° C. respectively. The same test set-up as the one used in flowrate testing was used in this experiment.

### C. Results and Discussion

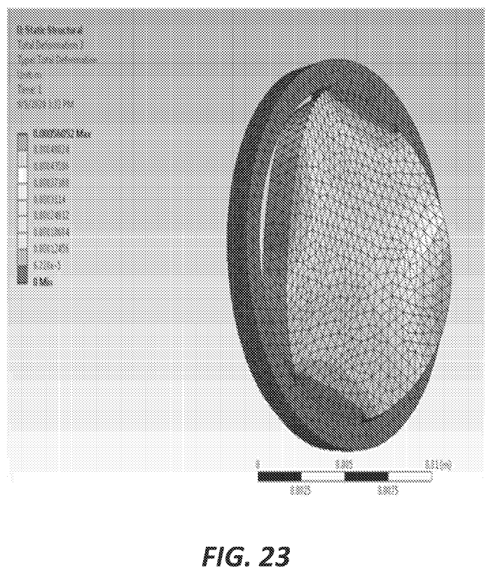

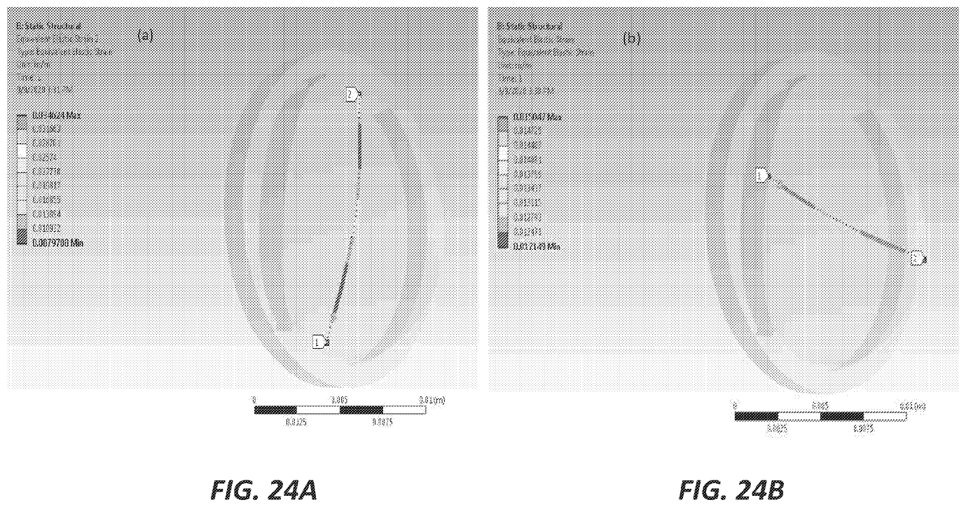

It can be seen from FIG. 23 that the deformations are the greatest at the tips of the flaps. However, finite element analysis performed in 2 paths at the center of the sensor aligned with y and x directions shown in FIG. 24A and FIG. 24B respectively, suggests that the resulting strains are the greatest on the top and bottom of the supporting beam close to where the sensor is restrained rather than in the middle. The values on the top and the bottom of the supporting middle beam are also greater than those on the tips of the flaps.

As can be seen from the plots of strain versus the length of the analyzed paths on FIG. 4-10(a) and FIG. 4-10(b) in the y and x directions respectively, magnitude of the strain in the sensor is a greater value at the top and bottom of the supporting beam rather than on the tips of the flaps. As a result of this analysis, the rGO patch was extended in the Y direction to enhance the sensitivity of the sensor to strain. Therefore, the initial square shape of the rGO film was replaced with a rectangular shape in the new design.

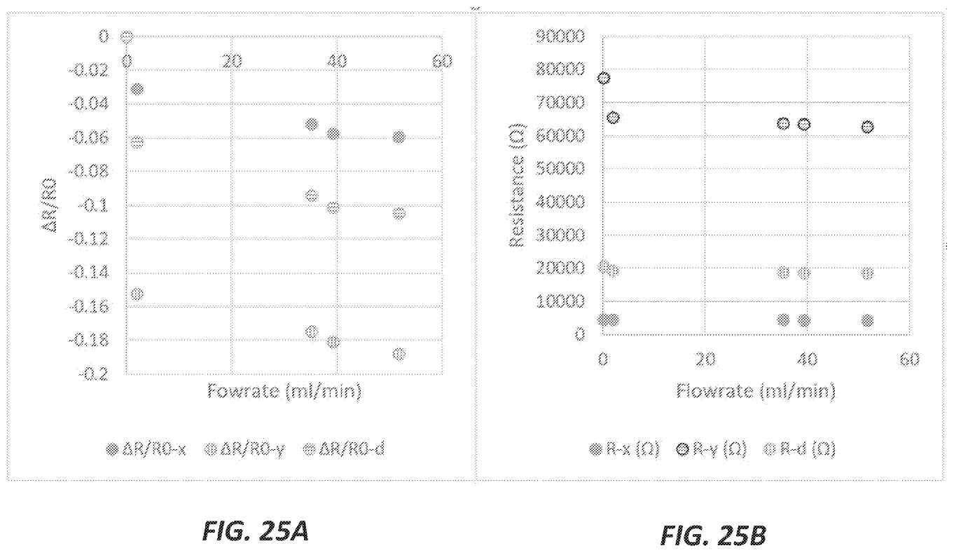

FIG. 25A and FIG. 25B show the resistance and relative resistance change in all 3 directions in one plot with respect to applied flowrate. As the figure suggests, the sensor was sensitive to the stimulus. The sensor showed higher sensitivity in the y direction. Resolution of about 2 ml/min was measured. The absolute value of the sensitivity of the sensor in the x, y and oblique directions were calculated as

$$0.0011 \frac{Ω / Ω}{ml / min} , 0.0036 \frac{Ω / Ω}{ml / min} and 0.00202 \frac{Ω / Ω}{ml / min}$$

which matches the results of FEM that suggested greater sensitivity of the sensor in the y direction.

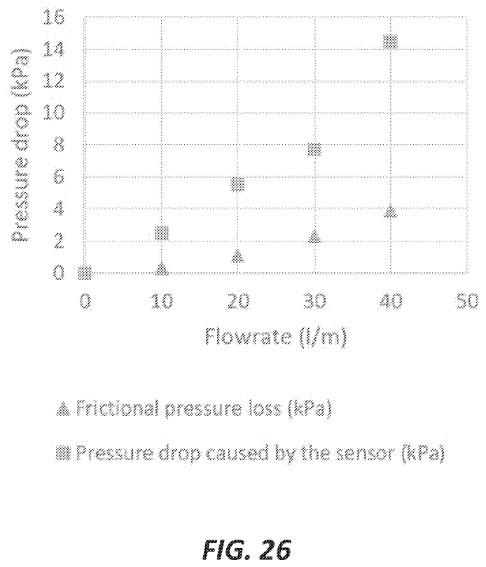

As can be seen in FIG. 26, the pressure-drop that sensor created at 40 l/min flowrate was 18.3 kPa where about 3.86 kPa of that value came from the frictional pressure loss in the pipe with diameter of 12.7 mm (half inch) and 45.72 cm long length. The frictional pressure loss was calculated based on Hazen-Williams Formula. Therefore, only 14.44 kPa of the pressure drop was caused by the sensor which is a very small amount of pressure-drop considering the pressure that pipes usually work at. For instance, residential water pressure ranges from about 310 kPa to about 550 kPa.

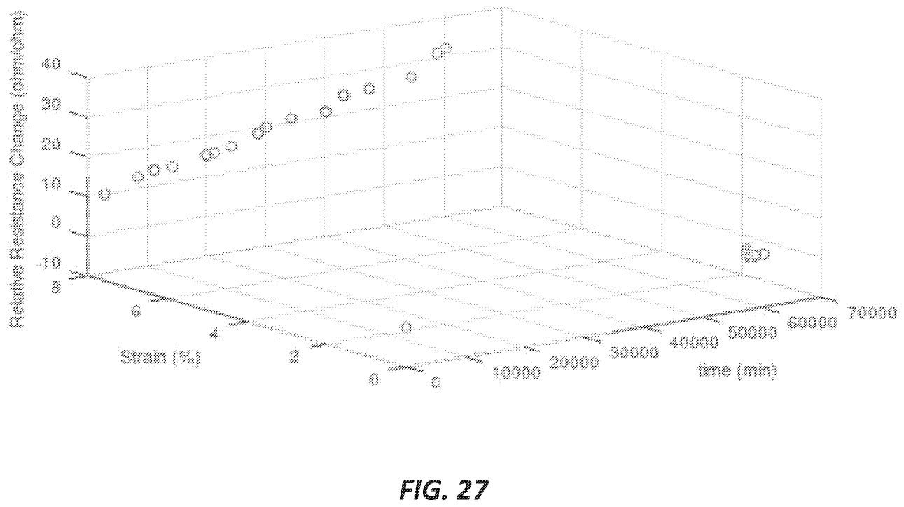

As shown in FIG. 27, small increasing changes in the resistive response of the sensor were observed during 57444 min (about 40 days) of being under 7.57% strain. After being released, the sensor's relative resistance change returned to almost the same value as its relaxed state's value was (before being strained) with only about 5Ω/Ω difference. A sensor's ability to return to its initial output value after being released is an important aspect of its performance and can be one of the requirements toward fulfilling good repeatability criteria. The test was performed at room temperature. The sample showed on average an increasing trend over time. Part of the increase in relative resistance change could be attributed to the increase in temperature in the room over time.

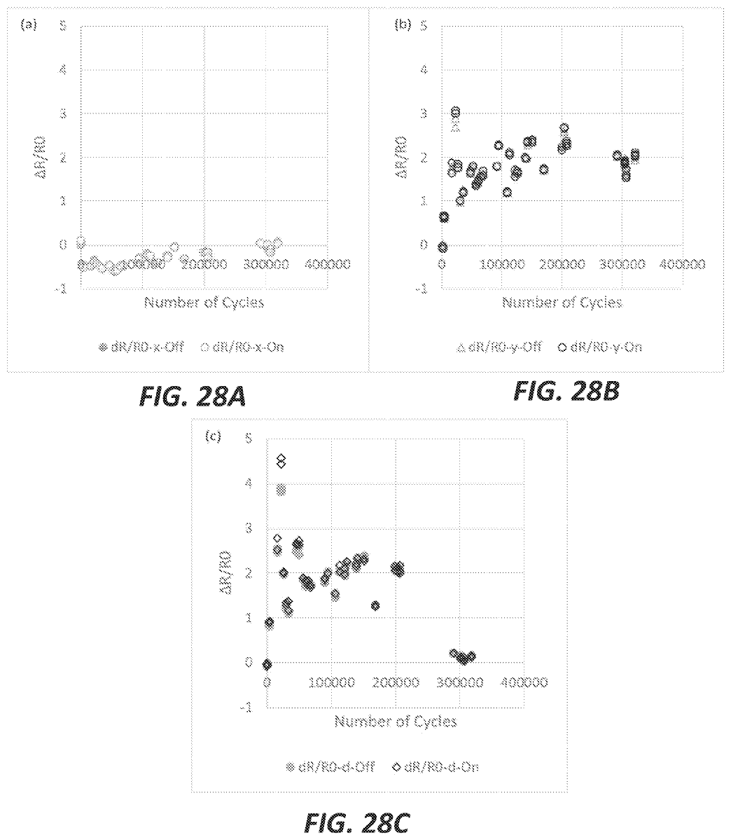

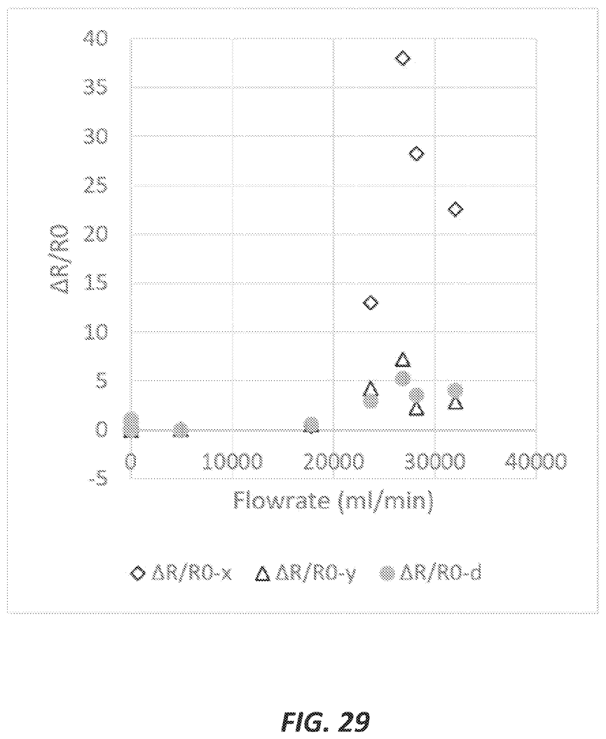

As shown in FIG. 28A, FIG. 28B, and FIG. 28C, during about 319000 cycles, the resistive response of the sensor showed very consistent result with variation of only, ±1, ±3 and ±5 in x, y and the oblique directions respectively. Most of these small variations happened in the first 10000 cycles and then resistive response of the sensor was mostly stabilized. The sensor in the x direction showed the most consistency in resistive response during the fatigue test.

FIG. 29 shows the highest flowrate that the sensor was tested up to. Not only did the sensor survive the flowrate as high as about 32035.83 ml/min but also once the applied flowrate returned to 0 ml/min, the resistive response of the sensor (ΔR/R₀) returned to its initial value with the very small differences of 0.193999Ω/Ω, 0.424458Ω/Ω and 0.8882Ω/Ω in x, y and the oblique directions respectively.

Summarizing the experimental results, finite element analysis showed that the rGO film should be extended along the y axis to show the best sensitivity to the flowrate change. The flowrate test on the sensor showed that it was sensitive to flowrate change and the most sensitivity was achieved in the resistive response of the sensor in y direction which was consistent with the results of the finite element analysis. Pressure drop test performed on the sensor showed that it created 14.44 kPa of pressure drop at 40 l/min flowrate which was a small amount of pressure drop considering residential water pipes being exposed to a pressure ranging from 310 kPa to about 550 kPa. The creep test showed a small increasing shift in the resistive response of the sensor during about 40 days of being under 7.57% strain. The increasing trend of the resistive response can be partially attributed to the increasing trend of temperature change in the room during data collection. During about 319000 cycles of cyclic testing, the resistive response of the sensor showed a very consistent result with variation of only, ±1, ±3 and ±5 in x, y and the oblique directions respectively. Testing the sensor at a flowrate as high as 32035.83 ml/min showed that not only did the sensor survive the high flowrate but also once the applied flowrate returned to 0 ml/min flowrate, the resistive response of the sensor (ΔR/R0) returned to its initial value with the very small differences of 0.193999Ω/Ω, 0.424458Ω/Ω and 0.8882Ω/Ω in x, y and the oblique directions respectively.

For reasons of completeness, the following Embodiments are provided.
Embodiment 1. A flow sensor disc, comprising:
   an outer ring;
   a beam extending across the outer ring;
   a first flap extending from the beam;
   a second flap extending from an opposite side of the beam as the first flap;
   a first flow opening defined between the first flap and the outer ring;
   a second flow opening defined between the second flap and the outer ring; and
   a multi-directional strain sensor supported by the beam.
Embodiment 2. The flow sensor disc of Embodiment 1, wherein the multi-directional strain sensor comprises reduced graphene oxide.
Embodiment 3. The flow sensor disc of Embodiment 1 or Embodiment 2, wherein the beam defines a cavity.
Embodiment 4. The flow sensor disc of any one of Embodiments 1-3, wherein a portion of the cavity comprises an air gap and a remainder portion of the cavity comprises either a polyimide material or a silicone polymer material.
Embodiment 5. The flow sensor disc of any one of Embodiments 1-4, wherein the first flap and the second flap are symmetrical.
Embodiment 6. The flow sensor disc of any one of Embodiments 1-5, wherein the first flap and the second flap have arcuate cross-sectional shapes.
Embodiment 7. The flow sensor disc of any one of Embodiments 1-6, wherein the first flap and the second flap are capable of flexing in a first direction and in a second direction.
Embodiment 8. The flow sensor disc of Embodiment 7, wherein the beam is capable of flexing in the first direction, the second direction, and a third direction.
Embodiment 9. The flow sensor disc of Embodiment 7 or Embodiment 8, wherein a width of the first flow opening and a width of the second flow opening increase when the first flap and the second flap are flexed in the first direction.
Embodiment 10. The flow sensor disc according to any one of Embodiments 1-9, wherein each of the outer ring, the beam, the first flap, and the second flap are integrally formed.
Embodiment 11. The flow sensor disc according to any one of Embodiments 1-10, wherein each of the outer ring, the beam, the first flap, and the second flap are a polyimide material or a silicone polymer material.
Embodiment 12. The flow sensor disc of any one of Embodiments 1-11, wherein the first flow opening and the second flow opening are arc shaped.
Embodiment 13. The flow sensor disc of any one of Embodiments 1-12, further comprising a plurality of wires connected to the multi-directional strain sensor.
Embodiment 14. The flow sensor disc of Embodiment 13, wherein:
   the multi-directional strain sensor has a rectangular shape with four corners, and
   the plurality of wires are connected adjacent to each corner of the multi-directional strain sensor.
Embodiment 15. The flow sensor disc of any one of Embodiments 1-14, further comprising a sealing layer disposed on a surface of the multi-directional strain sensor.
Embodiment 16. The flow sensor disc of any one of Embodiments 1-15, wherein a ratio between an outer diameter of the outer ring and an inner diameter of the outer ring is between 1.19 and 1.77.
Embodiment 17. The flow sensor disc of any one of Embodiments 1-16, wherein a ratio between an outer diameter of the outer ring and a width of the beam is between 2.45 and 3.67.
Embodiment 18. The flow sensor disc of any one of Embodiments 1-17, wherein a ratio between a thickness of the outer ring and a thickness of the multi-directional strain sensor is between 100 and 568.
Embodiment 19. The flow sensor disc of any one of Embodiments 1-18, wherein a ratio between a width of the beam and a width of the multi-directional strain is between 1.02 and 1.53.
Embodiment 20. The flow sensor disc of any one of Embodiments 1-19, wherein a ratio between a width of the beam and a width of a widest part of the first flap is between 2.45 and 3.67.
Embodiment 21. The flow sensor disc of any one of Embodiments 1-20, wherein a ratio between a width of the outer ring and a width of the first flow opening is between 1.91 and 2.85.
Embodiment 22. The flow sensor disc of any one of Embodiments 1-21, further comprising a frame disposed on the beam, wherein the multi-directional strain sensor is disposed within the frame.
Embodiment 23. The flow sensor disc of Embodiment 22, wherein the frame has a width between 0.50 cm and 1.00 cm, a length between 1 cm and 1.5 cm, a height between 0.05 cm and 0.15 cm, and a thickness between 0.025 cm and 0.10 cm.
Embodiment 24. The flow sensor disc of Embodiment 22 or Embodiment 23, wherein the frame has a width that is less than a width of the beam.
Embodiment 25. The flow sensor disc of any one of Embodiments 22-24, wherein a ratio of a width of the beam and a width of the frame is between 1.02 and 1.53.
Embodiment 26. The flow sensor disc of any one of Embodiments 1-25, wherein:
   the outer ring has an outer diameter between 2.00 cm and 2.50 cm;
   the outer ring has an inner diameter between 1.00 cm and 2 cm;
   the beam has a width between 0.50 cm and 1.00 cm and a length between 1 cm and 1.5 cm;
   the reduced graphene oxide sensor has a width between 0.50 cm and 1.00 cm and a length between 1 cm and 1.5 cm;
   the outer ring has a thickness between 0.20 cm and 0.30 cm;
   the first flow opening and the second flow opening have a width between 0.20 cm and 0.50 cm;
   the first flap and the second flap have a thickness between 0.20 cm and 0.30 cm; and
   the multi-directional strain sensor has a maximum thickness between 0.0000015 cm and 0.000003 cm.
Embodiment 27. A method for making a flow sensor disc, the method comprising:
   depositing a silicone-based material into a mold, the mold defining:
      an outer ring,
      a beam extending across the outer ring,
      a first flap extending from the beam,
      a second flap extending from an opposite side of the beam as the first flap,
      a first flow opening defined between the first flap and the outer ring,
      a second flow opening defined between the second flap and the outer ring, and
      a frame,
   curing the silicone-based material in the mold, thereby generating a disc;
   removing the disc from the mold;
   depositing graphene oxide into the frame; and
   reducing the graphene oxide to reduced graphene oxide, thereby generating the flow sensor disc.
Embodiment 28. The method for making a flow sensor disc of Embodiment 27, wherein the silicone-based material is cured for a cure time of at least 72 hours at a cure temperature between 23-30° C.
Embodiment 29. The method for making a flow sensor disc of Embodiment 27 or Embodiment 28, the method further comprising attaching at least two wires to the reduced graphene oxide.
Embodiment 30. The method for making a flow sensor disc of any one of Embodiments 27-29, the method further comprising electrically connecting the at least two wires to a computing unit configured to receive signals from the at least two wires and determine a flow condition and/or a pressure condition.
Embodiment 31. The method for making a flow sensor disc of any one of Embodiments 27-30, wherein:
   the reduced graphene oxide has a rectangular shape with four corners, and
   the wires are attached adjacent a corner of the reduced graphene oxide.
Embodiment 32. The method for making a flow sensor disc of any one of Embodiments 27-31, the method further comprising applying a seal layer to at least one side of the flow sensor disc.
Embodiment 33. The method of making a flow sensor disc of any one of Embodiments 27-32, the method further comprising applying a seal to a surface the reduced graphene oxide.
Embodiment 34. The method for making a flow sensor disc of any one of Embodiments 27-33, the method further comprising preparing the disc for the graphene oxide by plasma etching the for at least three minutes.
Embodiment 35. The method for making a flow sensor disc of any one of Embodiments 27-34, the method further comprising preparing the disc for the graphene oxide by immersing the disc in a medium, wherein the medium contains Ethanol and APTES, and wherein the disc is immersed for at least 2 hours.
Embodiment 36. The method for making a flow sensor disc of any one of Embodiments 27-35, wherein:
   the outer ring has a thickness of 0.20 cm and 0.30 cm;
   the first flap and the second flap have a thickness between 0.20 cm and 0.30 cm; and
   the reduced graphene oxide has a maximum thickness between 0.0000015 cm and 0.000003 cm.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

1. A flow sensor disc, comprising:
an outer ring;
a beam extending across the outer ring;
a first flap extending from the beam;
a second flap extending from an opposite side of the beam as the first flap;
a first flow opening defined between the first flap and the outer ring;
a second flow opening defined between the second flap and the outer ring; and
a multi-directional strain sensor supported by the beam.

2. The flow sensor disc of claim 1, wherein the multi-directional strain sensor comprises reduced graphene oxide; and
wherein the first flap and the second flap are symmetrical.

3. The flow sensor disc of claim 1, wherein the beam defines a cavity; and
wherein a portion of the cavity comprises an air gap and a remainder portion of the cavity comprises either a polyimide material or a silicone polymer material.

4-5. (canceled)

6. The flow sensor disc of claim 1, wherein the first flap and the second flap have arcuate cross-sectional shapes; and
wherein the first flow opening and the second flow opening are arc shaped.

7. The flow sensor disc of claim 1, wherein the first flap and the second flap are capable of flexing in a first direction and in a second direction.

8. The flow sensor disc of claim 7, wherein the beam is capable of flexing in the first direction, the second direction, and a third direction; and
wherein a width of the first flow opening and a width of the second flow opening increase when the first flap and the second flap are flexed in the first direction.

9. (canceled)

10. The flow sensor disc according to claim 1, wherein each of the outer ring, the beam, the first flap, and the second flap are integrally formed; and
wherein each of the outer ring, the beam, the first flap, and the second flap are a polyimide material or a silicone polymer material.

11-12. (canceled)

13. The flow sensor disc of claim 1, further comprising a plurality of wires connected to the multi-directional strain sensor;
wherein the multi-directional strain sensor has a rectangular shape with four corners, and
wherein the plurality of wires are connected adjacent to each corner of the multi-directional strain sensor.

14. (canceled)

15. The flow sensor disc of claim 1, further comprising a sealing layer disposed on a surface of the multi-directional strain sensor.

16. The flow sensor disc of claim 1, wherein a ratio between an outer diameter of the outer ring and an inner diameter of the outer ring is between 1.19 and 1.77;
wherein a ratio between an outer diameter of the outer ring and a width of the beam is between 2.45 and 3.67; and
wherein a ratio between a thickness of the outer ring and a thickness of the multi-directional strain sensor is between 100 and 568.

17-18. (canceled)

19. The flow sensor disc of claim 1, wherein a ratio between a width of the beam and a width of the multi-directional strain is between 1.02 and 1.53;
wherein a ratio between a width of the beam and a width of a widest part of the first flap is between 2.45 and 3.67; and
wherein a ratio between a width of the outer ring and a width of the first flow opening is between 1.91 and 2.85.

20-21. (canceled)

22. The flow sensor disc of claim 1, further comprising a frame disposed on the beam, wherein the multi-directional strain sensor is disposed within the frame;
wherein the frame has a width between 0.50 cm and 1.00 cm, a length between 1 cm and 1.5 cm, a height between 0.05 cm and 0.15 cm, and a thickness between 0.025 cm and 0.10 cm;
wherein the frame has a width that is less than a width of the beam; and
wherein a ratio of a width of the beam and a width of the frame is between 1.02 and 1.53.

23-25. (canceled)

26. The flow sensor disc of claim 1, wherein:
the outer ring has an outer diameter between 2.00 cm and 2.50 cm;
the outer ring has an inner diameter between 1.00 cm and 2 cm;
the beam has a width between 0.50 cm and 1.00 cm and a length between 1 cm and 1.5 cm;
the reduced graphene oxide sensor has a width between 0.50 cm and 1.00 cm and a length between 1 cm and 1.5 cm;
the outer ring has a thickness between 0.20 cm and 0.30 cm;
the first flow opening and the second flow opening have a width between 0.20 cm and 0.50 cm;
the first flap and the second flap have a thickness between 0.20 cm and 0.30 cm; and
the multi-directional strain sensor has a maximum thickness between 0.0000015 cm and 0.000003 cm.

27. A method for making a flow sensor disc, the method comprising:
depositing a silicone-based material into a mold, the mold defining:
an outer ring,
a beam extending across the outer ring,
a first flap extending from the beam,
a second flap extending from an opposite side of the beam as the first flap,
a first flow opening defined between the first flap and the outer ring,
a second flow opening defined between the second flap and the outer ring, and
a frame,
curing the silicone-based material in the mold, thereby generating a disc;
removing the disc from the mold;
depositing graphene oxide into the frame; and
reducing the graphene oxide to reduced graphene oxide, thereby generating the flow sensor disc.

28. The method for making a flow sensor disc of claim 27, wherein the silicone-based material is cured for a cure time of at least 72 hours at a cure temperature between 23-30° C.

29. The method for making a flow sensor disc of claim 28, the method further comprising:
attaching at least two wires to the reduced graphene oxide;
electrically connecting the at least two wires to a computing unit configured to receive signals from the at least two wires; and
determining a flow condition and/or a pressure condition
wherein:
the reduced graphene oxide has a rectangular shape with four corners, and
the wires are attached adjacent a corner of the reduced graphene oxide.

30-31. (canceled)

32. The method for making a flow sensor disc of claim 27, the method further comprising:
applying a seal layer to at least one side of the flow sensor disc; and
applying a seal to a surface of the reduced graphene oxide.

33. (canceled)

34. The method for making a flow sensor disc of claim 27, the method further comprising preparing the disc for the graphene oxide by plasma etching the disc for at least three minutes.

35. The method for making a flow sensor disc of claim 27, the method further comprising preparing the disc for the graphene oxide by immersing the disc in a medium, wherein the medium contains Ethanol and APTES, and wherein the disc is immersed for at least 2 hours.

36. The method for making a flow sensor disc of claim 27, wherein:
the outer ring has a thickness of 0.20 cm and 0.30 cm;
the first flap and the second flap have a thickness between 0.20 cm and 0.30 cm; and
the reduced graphene oxide has a maximum thickness between 0.0000015 cm and 0.000003 cm.
